(19) United States
(12) Patent Application Publication
(10) Pub. No.: US 2019/0074638 A1
(43) Pub. Date: Mar. 7, 2019

(54) POWER CORD PLUG, CABLE, POWER CORD STRUCTURE AND ELECTRICAL DEVICE

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Jianliang MA, Foshan (CN); Zhenfeng ZHANG, Foshan (CN); Songtao LI, Foshan (CN)

(21) Appl. No.: 16/177,401

(22) Filed: Oct. 31, 2018

Related U.S. Application Data
(63) Continuation of application No. PCT/CN2017/091327, filed on Jun. 30, 2017.

(30) Foreign Application Priority Data
Aug. 30, 2016 (CN) 201610773235.3
Aug. 30, 2016 (CN) 201620996014.8
Aug. 30, 2016 (CN) 201620999746.2
Aug. 30, 2016 (CN) 201620999817.9
Jun. 16, 2017 (CN) 201720705127.2

(51) Int. Cl. H01R 13/66; H01R 13/52; G08C 17/00; H01Q 1/24

(52) U.S. Cl. CPC H01R 13/665; H01R 13/5219; H01R 13/504; G08C 17/00; H01Q 1/24; H01R 13/5213

(57) ABSTRACT

The present disclosure provides a power cord plug, a power cord structure and an electrical device for a power cord, and the power cord plug includes: a shell, and a communication device and an antenna arranged in the shell. According to the power cord plug provided by the present disclosure, as the communication device and the antenna are arranged in the shell of the power cord plug, the communication device is far away from the electrical device, so the communication ability of the communication device will not be shielded by the metal shell of the electrical device, and will not be affected by a motor, a circuit board, coils, a magnetron and other factors in the electrical device, or affected by the high temperature caused by the operation of the equipment, accordingly the communication device works in a good environment, and the working reliability and stability of the communication device are guaranteed.

### CROSS-REFERENCE TO RELATED APPLICATIONS

This application is a continuation of International Application PCT/CN2017/091327, filed on Jul. 14, 2017, which claims the priority of the Chinese Patent Application No. 201620996014.8 entitled “POWER CORD PLUG POWER CORD STRUCTURE AND ELECTRICAL DEVICE”, the Chinese Patent Application No. 201620999746.2 entitled “CABLE, POWER CORD STRUCTURE AND ELECTRICAL DEVICE”, the Chinese Patent Application No. 201620999817.9 entitled “POWER CORD PLUG POWER CORD STRUCTURE AND ELECTRICAL DEVICE”, and the Chinese Patent Application No. 201610773235.3 entitled “POWER CORD PLUG POWER CORD STRUCTURE AND ELECTRICAL DEVICE”, filed in the Chinese Patent Office on Aug. 30, 2016, and the Chinese Patent Application No. 201720705127.2 entitled “POWER CORD STRUCTURE AND ELECTRICAL DEVICE”, filed in the Chinese Patent Office on Jun. 16, 2017, the entire contents of which are herein incorporated by reference.

### FIELD OF THE DISCLOSURE

The present disclosure relates to the field of electrical device, and in particular, to a power cord plug, a cable, a power cord structure and an electrical device.

### BACKGROUND OF THE DISCLOSURE

An electrical device is connected to a network or interconnected with other equipment through different communication devices. The communication devices include, but not limited to, WIFI devices, Bluetooth devices, ZIGBEE devices, and the structure design of the communication device on the electrical device in related art mainly includes the following several manners:

The communication device is designed in the electrical device. In this manner, the communication device will be shielded by a metal shell of the electrical device and will be interfered by a motor, a circuit board, coils, a magnetron and the like in the household appliance.

The communication device is designed on the shell of the electrical device. In this manner, the communication ability of the communication device will be influenced by the metal shell of the electrical device and will also be affected by the high temperature produced by the electrical device, and this mounting manner will affect the appearance consistency of the household appliance and increase the overall size of the household appliance, thereby being not beautiful or practical.

The communication device is designed in the household appliance, and the antenna of the communication device is led out alone and is designed at the outside of the household appliance. This manner will affect the appearance consistency of the household appliance, and as the additional antenna portion is increased at the outside of the household appliance, the size of the household appliance is increased, thereby being not beautiful or practical. Moreover, the antenna mounted at the outside is liable to be damaged.

In summary, due to the existing structure design of the communication device in related art, the communication device is vulnerable to being shielded, vulnerable to high temperature and vulnerable to the interference of other electronic devices, and the appearance consistency of the household appliance is also affected, thereby being not beautiful or practical.

### SUMMARY OF THE DISCLOSURE

One embodiment of the present disclosure is to provide a power cord structure.

One embodiment of the present disclosure is to provide a cable.

One embodiment of the present disclosure is to provide a power cord structure.

One embodiment of the present disclosure is to provide a power cord plug.

One embodiment of the present disclosure is to provide a power cord structure.

One embodiment of the present disclosure is to provide a power cord plug.

One embodiment of the present disclosure is to provide a power cord structure.

One embodiment of the present disclosure is to provide a power cord structure.

One embodiment of the present disclosure is to provide an electrical device.

In view of this, one embodiment of the present disclosure, the present disclosure provides a power cord plug for a power cord, including: a shell; a communication device arranged in the shell; and an antenna arranged in the shell and connected with the communication device for enabling the communication device to receive and send signals.

According to the power cord plug provided by the present disclosure, as the communication device is arranged in the shell of the power cord plug, the communication device can be far away from the electrical device, so the communication ability of the communication device will not be shielded by the metal shell of the electrical device, and will not be affected by a motor, a circuit board, coils, a magnetron and other factors in the electrical device, or affected by the high temperature caused by the operation of the equipment, accordingly the communication device works in a good environment, and the working reliability and stability of the communication device are guaranteed; moreover, the antenna is arranged in the shell and is connected with the communication device for enabling the communication device to receive and send signals, so the connection path between the communication device and the antenna can be shortened, signal transmission is benefited, and the antenna is protected from being damaged easily, thereby improving the working reliability; meanwhile, by means of the inner space of the shell of the power cord plug, no additional size is added to the electrical device, thereby guaranteeing the beauty of the overall appearance, guaranteeing convenience for carrying and improving the user experience.

In addition, the power cord plug in the above-mentioned embodiment provided by the present disclosure can further have the following additional technical features:

In the above-mentioned technical solution, the power cord plug further includes: a conducting wire, one end of the conducting wire is connected with the communication device, and the other end of the conducting wire is connected with an electrical device.

In the technical solution, the conducting wire connects the communication device in the power cord plug with the electrical device, and the electrical device is connected with the network or interconnected with other electrical device through the communication device to perform data transmission so as to realize the intelligent control of the electrical device.

In the above-mentioned technical solution, the power cord plug is of an integrated sealed structure.

In the technical solution, the power cord plug adopts the plastic integrated sealed structure, and the communication device at the middle may not be detached, thereby effectively guaranteeing the fixation of the communication device, preventing the interruption of communication signals caused by drop and disconnection and improving the user experience, moreover damage caused by water inflow and other problems can also be prevented, so that the communication device, the antenna and the like in the power cord plug are fully protected, and the service lives are prolonged; meanwhile, the plastic integrated structure can be directly formed by injection molding during processing without being assembled, thereby being convenient to process, and thus the processing cost is reduced; and in addition, the integrated sealed structure can also prevent current leakage in use, thereby protecting the safety of users.

In the above-mentioned technical solution, the power cord plug further includes: a protective sheath sheathed on the communication device for protecting the communication device.

In the technical solution, the communication device is sheathed in the protective sheath, and due to different temperatures and pressures of different injection molding processes, in order to protect the communication device from being damaged in an injection molding process, the assorted protective sheath can be selected to protect the communication device in the injection molding process, thereby guaranteeing the reliability of the quality of the produced power cord plug.

In any one of the above-mentioned technical solutions, the communication device is a wireless communication device.

In the technical solution, the communication device adopts wireless communication and is cooperatively used with the antenna, so that the user can realize the remote control of the electrical device through wireless equipment, and the user not only can conveniently control the electrical device that is difficult to touch, but also can simultaneously operate multiple pieces of electrical device having wireless communication functions at one position, thereby saving time and improving the user experience.

In the above-mentioned technical solution, the wireless communication device includes at least one of the following devices: a wifi device, a Bluetooth device and an infrared device.

In the technical solution, the wireless communication device is a communication device having complete functions, and the wifi device can realize the network access control of the electrical device, and the user can operate the electrical device even at outdoors, thereby helping the user to make full use of time; the Bluetooth device can perform data transmission with the electrical device indoors; and the infrared device can be used for remotely controlling the electrical device, so the control of the household appliance is more convenient, and the infrared device can also be used for thermal imaging so as to be adapted to the working demands of electrical device. The wireless communication device having complete functions can satisfy comprehensive needs of the user for all kinds of electrical device, thereby improving the application range of the power cord plug.

One embodiment of the present disclosure, a power cord structure is further provided for an electrical device, including: the power cord plug in any one of the above-mentioned technical solutions; and a power cord connected with the power cord plug.

The power cord structure provided by One embodiment of the present disclosure includes the power cord plug in any one of the above-mentioned technical solutions and the power cord connected with the power cord plug, therefore the power cord structure has all the beneficial effects of the power cord plug, and the power cord plug is connected with the electrical device through the power cord so as to guarantee the power supply and the connection between the communication device and the electrical device.

In the above-mentioned technical solution, the conducting wire and the power cord are of an integrated structure, and the conducting wire is integrated in the power cord.

In the technical solution, the conducting wire for connecting the communication device with the electrical device is integrated with the power cord, so that the connecting circuits of the communication device and the power supply with the electrical device are merged, the circuit layout is more neat, meanwhile a rubber coating structure of the power cord protects the conducting wire, thereby not only prolonging the service life of the conducting wire, but also guaranteeing the safety of the user in daily use.

One embodiment of the present disclosure, the present disclosure provides a cable, including: at least two power cords coated with a first insulating layer; at least one data line coated with a second insulating layer; and a third insulating layer, and the third insulating layer coating at the outside of the power cords and the data lines, which have been respectively coated with the first insulating layer and the second insulating layer.

The cable provided by the present disclosure includes at least two power cords for providing electric power to the electrical device, and at least one data line for connecting the communication device with the electrical device and transmitting signals, and the number of the data lines can be determined according to needs. The outside of the power cords and the data lines is respectively coated with the insulating layer, then an insulating layer coats at the outside of the power cords and the data lines, which have been respectively coated with the first insulating layer and the second insulating layer, as the power cords and the data lines are deployed in the same cable, the circuit layout of the electrical device can be simplified, meanwhile the power cords and the data lines are respectively coated with the insulating layer, so there are enough gaps between data lines and the power cords to separate strong wires from weak wires, the electrical conduction between different circuits can be cut off to guarantee the safety of use, and the interference of the power cords to the data lines can also be avoided.

In addition, the cable in the above-mentioned embodiment provided by the present disclosure can further have the following additional technical features:

In the above-mentioned technical solution, the outside of each data line is coated with the insulating layer.

In the technical solution, as the outside of each data line is coated with the insulating layer, the electrical conduction and mutual interference between different data lines can be isolated.

In the above-mentioned technical solution, four data lines are set, and the outside of the entirety of the four data lines is coated with a shielding layer.

In the technical solution, the outside of the entirety of the data lines is coated with the shielding layer, so there are enough gaps between the data lines and the power cords to ensure that the data lines are not interfered by the strong current of the power cords and to ensure the reliability and stability of signal transmission of the data lines.

In the above-mentioned technical solution, the power cord includes a power live wire and a power zero line; and the outside of the power live wire and the power zero line is coated singly with an insulating layer.

In the technical solution, the power live wire and the power zero line can satisfy the needs of daily power supply of the electrical device, and the outside of the power live wire and the power zero line is coated singly with the insulating layer so as to isolate the electrical conduction, prevent fire accidents of the electrical device caused by the short circuit of the power live wire and the power zero line, and protect the personal and property safety.

In the above-mentioned technical solution, the power cord further includes a power ground line, and the outside of the power ground line is also singly coated with an insulating layer.

In the technical solution, the power ground line can satisfy the safety demands of high-power electrical device in a use process and form ground protection. As the outside of the power ground line is coated with the insulating layer, current leakage protection can be formed.

In any one of the above-mentioned technical solutions, the cross section of the cable is shaped like a circle or a FIG. 8.

In the technical solution, after the power cords and the data lines are integrally coated with rubber, the cross section can be shaped like a circle, the FIG. 8, a rectangle and other shapes depending on circumstances, as long as the processing is convenient and the use is comfortable.

One embodiment of the present disclosure, a power cord structure is further provided, including: a power cord plug; and the cable in any one of the above-mentioned technical solutions; and the power cord plug is connected with the cable.

The power cord structure provided by one embodiment of the present disclosure includes the cable in any one of the above-mentioned technical solutions, thereby having all the beneficial effects of the cable.

In the above-mentioned technical solution, the power cord structure further includes a communication device arranged in the power cord plug and connected with the data lines.

In the technical solution, the communication device is arranged in the power cord plug, and a communication signal is transmitted to the electrical device by the data lines, thereby realizing the network connection of the electrical device or the interconnection with other equipment, and helping the user to intelligently control the electrical device.

One embodiment of the present disclosure, the present disclosure provides a power cord plug for a power cord, including: a shell; a communication device arranged in the shell; and a cover body arranged on the shell, and the cover body is detachably mounted on the shell.

According to the power cord plug provided by the present disclosure, as the communication device is arranged in the shell of the power cord plug, the communication device can be far away from the electrical device, so the communication ability of the communication device will not be shielded by the metal shell of the electrical device, and will not be affected by the motor, the circuit board, the coils, the magnetron and other factors in the electrical device, or affected by the high temperature caused by the operation of the equipment, accordingly the communication device works in a good environment, and the working reliability and stability of the communication device are guaranteed; meanwhile, by means of the inner space of the shell of the power cord plug, no additional size is added to the electrical device, thereby guaranteeing the beauty of the overall appearance, guaranteeing convenience for carrying and improving the user experience; and moreover, as the cover body is arranged on the shell, and the cover body is detachably mounted on the shell, when a component in the shell is damaged, troubleshooting is facilitated for maintenance and component replacement.

In addition, the power cord plug in the above-mentioned embodiment provided by the present disclosure can further have the following additional technical features:

In the above-mentioned technical solution, the power cord plug further includes: an antenna arranged in the shell and connected with the communication device for enabling the communication device to receive and send signals.

In the technical solution, both the communication device and the antenna are arranged in the power cord plug, thereby being able to shorten the connection path between the communication device and the antenna and facilitate signal transmission; meanwhile, it is avoided that additional antenna portions are increased at the outside of the electrical device to increase the size of the electrical device, thereby guaranteeing the beauty and practicability of the electrical device, protecting the antenna from being damaged easily and improving the working reliability.

In the above-mentioned technical solution, the power cord plug further includes: a conducting wire, and one end of the conducting wire is connected with the communication device, and the other end of the conducting wire is connected with the electrical device.

In the technical solution, one end of the conducting wire is connected with the communication device, and the other end of the conducting wire is connected with the electrical device, therefore the electrical device is connected with the network or interconnected with other electrical device through the communication device to perform data transmission so as to realize the intelligent control of the electrical device.

In the above-mentioned technical solution, a buckle is arranged on one of the shell and the cover body, and a slot matched with the buckle is arranged on the other one of the shell and the cover body.

In the technical solution, the cover body and the shell are matched through the buckle and the slot, and when the components in the shell are damaged, the components are convenient to detach and install for maintenance and component replacement. In implementation, the cover body and the shell can be fixedly mounted in other manners such as screw connection, etc.

In the above-mentioned technical solution, the communication device is a wireless communication device.

In the technical solution, the communication device is the wireless communication device and is cooperatively used with the antenna, so that the user can realize the remote control of the electrical device through wireless equipment, and the user can not only conveniently control the electrical device that is difficult to touch, but also can simultaneously operate multiple pieces of electrical device having wireless communication functions at one position, thereby saving time and improving the user experience.

In the above-mentioned technical solution, the wireless communication device includes at least one of the following devices: a wifi device, a Bluetooth device and an infrared device.

In the technical solution, the wireless communication device is a communication device having complete functions, and the wifi device can realize the network access control of the electrical device, and the user can operate the electrical device even at outdoors, thereby helping the user to make full use of time; the Bluetooth device can perform data transmission with the electrical device indoors; and the infrared device can be used for remotely controlling the electrical device, so the control of the household appliance is more convenient, and the infrared device can also be used for thermal imaging so as to be adapted to the working demands of electrical device. The wireless communication device having complete functions can satisfy comprehensive needs of the user for all kinds of electrical device, thereby improving the application range of the power cord plug.

One embodiment of the present disclosure, a power cord structure is further provided for an electrical device, including: the power cord plug in any one of the above-mentioned technical solutions; and a power cord connected with the power cord plug.

The power cord structure provided by one embodiment of the present disclosure includes the power cord plug in any one of the above-mentioned technical solutions and the power cord connected with the power cord plug, therefore the power cord structure has all the beneficial effects of the power cord plug, and the power cord plug is connected with the electrical device through the power cord so as to guarantee the power supply and the connection between the communication device and the electrical device.

In the above-mentioned technical solution, the conducting wire and the power cord are of an integrated structure, and the conducting wire is integrated in the power cord.

In the technical solution, the conducting wire and the power cord are set as the integrated structure, so that the connecting circuits of the communication device and the power supply with the electrical device are merged, the circuit layout is more neat, meanwhile the rubber coating structure of the power cord protects the conducting wire, thereby not only prolonging the service life of the conducting wire, but also guaranteeing the safety of the user in daily use.

One embodiment of the present disclosure, the present disclosure provides a power cord plug for a power cord, including: a shell; and an antenna arranged in the shell.

According to the power cord plug provided by the present disclosure, as the antenna is arranged in the shell, the antenna does not need to be exposed to the outside, so that the antenna can be protected from being damaged easily, and the antenna can work in a good environment, thereby guaranteeing the working reliability and stability of the antenna; meanwhile, by means of the inner space of the shell of the power cord plug, no additional size is added to the electrical device, thereby guaranteeing the beauty of the overall appearance, guaranteeing convenience for carrying and improving the user experience.

In addition, the power cord plug in the above-mentioned embodiment provided by the present disclosure can further have the following additional technical features:

In the above-mentioned technical solution, the power cord plug further includes: a communication device arranged in the shell and connected with the antenna.

In the technical solution, the communication device is arranged in the power cord plug, thereby not only being able to shorten the connection path between the communication device and the antenna and facilitate signal transmission, but also avoiding increasing additional communication devices and antenna portions at the outside of the electrical device to increase the size of the electrical device, and guaranteeing the appearance consistency, beauty and practicability of the electrical device; meanwhile, as the communication device is arranged in the shell, the communication device can be far away from the electrical device, so the communication ability of the communication device will not be shielded by the metal shell of the electrical device, and will not be affected by the motor, the circuit board, the coils, the magnetron and other factors in the electrical device, or affected by the high temperature caused by the operation of the equipment, accordingly the communication device works in a good environment, and the working reliability and stability of the communication device are guaranteed.

In any one of the above-mentioned technical solutions, the power cord plug further includes: a conducting wire, one end of the conducting wire is connected with the communication device or the antenna, and the other end of the conducting wire is connected with the electrical device.

In the technical solution, on the one hand, when both the communication device and the antenna are arranged in the shell, the antenna is connected with the communication device, and the antenna quickly transmits a received signal to the communication device and transmits the signal to the electrical device through the conducting wire so as to realize the intelligent control of the electrical device. On the other hand, the communication device and the antenna are not located on the same position, the communication device can be designed in the electrical device or on the shell, the antenna of the communication device is led out by the conducting wire and is designed on the position of the power cord plug, and the antenna transmits the signal to the communication device of the electrical device through the conducting wire after receiving the signal so as to realize the intelligent control of the electrical device.

In the above-mentioned technical solution, the power cord plug is of an integrated sealed structure.

In the technical solution, the power cord plug adopts the plastic integrated sealed structure, and the communication device or the antenna located in the power cord plug may not be detached, thereby effectively guaranteeing the fixation of the communication device or the antenna, preventing the interruption of communication signals caused by drop and disconnection and improving the user experience, moreover, damage caused by water inflow and other problems can also be prevented, so that the communication device or the antenna and the like in the power cord plug are fully protected, and the service lives are prolonged; meanwhile, the plastic integrated structure can be directly formed by injection molding during processing without being assembled, thereby being convenient to process, and thus the processing cost is reduced.

In the above-mentioned technical solution, the shell is detachably mounted on the power cord plug.

In the technical solution, the shell is mounted on the power cord plug and can be detached, thereby being convenient to troubleshoot for maintenance and component replacement.

In the above-mentioned technical solution, the power cord plug further includes: a cover body, and the cover body is detachably arranged on the shell.

In the technical solution, as the cover body is arranged on the shell, and the cover body is detachably mounted on the shell, when any one of the communication device, the antenna and the conducting wire in the shell is damaged, troubleshooting is facilitated for maintenance and component replacement.

In any one of the above-mentioned technical solutions, the power cord plug further includes: a protective sheath sheathed on the communication device or the antenna for protecting the communication device or the antenna.

In the technical solution, on the one hand, when the power cord plug is of the integrated sealed structure, due to different temperatures and pressures of different injection molding processes, in order to protect the communication device or the antenna from being damaged in the injection molding process, the assorted protective sheath can be selected to protect the communication device or the antenna in the injection molding process, thereby guaranteeing the reliability of the quality of the produced power cord plug. On the other hand, when the power cord plug is of a detachable structure, the communication device or the antenna in the power cord plug may be exposed to the outside due to fault maintenance or accidental opening, therefore the protective sheath can protect the communication device or the antenna from being damaged at this time.

In any one of the above-mentioned technical solutions, the communication device is a wireless communication device.

In the technical solution, the communication device adopts wireless communication, so that the user can realize remote control of the electrical device through wireless equipment, and the user can not only conveniently control the electrical device that is difficult to touch, but also can simultaneously operate multiple pieces of electrical device having wireless communication functions at one position, thereby saving time and improving the user experience.

In the above-mentioned technical solution, the wireless communication device includes at least one of the following devices: a wifi device, a Bluetooth device and an infrared device.

In the technical solution, the wireless communication device is a communication device having complete functions, and the wifi device can realize the network access control of the electrical device; the Bluetooth device can perform data transmission with the electrical device indoors; and the infrared device can be used for remotely controlling the electrical device, so the control of the household appliance is more convenient, and the infrared device can also be used for thermal imaging so as to be adapted to the working demands of electrical device. The wireless communication device having complete functions can satisfy comprehensive needs of the user for all kinds of electrical device, thereby improving the application range of the power cord plug.

One embodiment of the present disclosure, a power cord structure is further provided for an electrical device, including: the power cord plug in any one of the above-mentioned technical solutions; a power cord connector; and a power cord, and one end of the power cord is connected with the power cord plug, and the other end of the power cord is connected with the power cord connector.

The power cord structure provided by one embodiment of the present disclosure includes the power cord plug in any one of the above-mentioned technical solutions and the power cord connected with the power cord plug, therefore the power cord structure has all the beneficial effects of the power cord plug. The communication device and/or the antenna are/is singly designed on the position of the power cord plug, so the problems of shielding, high temperature, interference, beauty and the like of the communication device can be solved. Due to the power cord connector, the power cord (including the conducting wire) is not fixed to the electrical device, but is connected with the electrical device by adopting a pluggable interface form, the detachable power cord is more convenient for the movement of the electrical device and can also protect the connecting site of the power cord and the electrical device from being damaged in a carrying process, meanwhile, when the power cord is faulty and may not be maintained, only the power cord is replaced, and the electrical device can be used continuously.

In the above-mentioned technical solution, the conducting wire and the power cord are of an integrated structure, and the conducting wire is integrated in the power cord.

In the technical solution, the conducting wire for connecting the communication device with the electrical device is integrated with the power cord, so that the connecting circuits of the communication device and the power supply with the electrical device are merged, the circuit layout is more neat, meanwhile the rubber coating of the power cord protects the circuits, thereby not only prolonging the service lives of the circuits, but also guaranteeing the safety of the user in daily use.

In the above-mentioned technical solution, the power cord connector includes: a power cord interface connected with the power cord; and a data line interface connected with the conducting wire.

In the technical solution, the power cord connector is provided with the power cord interface and the data line interface, which can be respectively connected with the power cord and the conducting wire, therefore the power supply is connected with the electrical device through the power cord to provide electric power for the electrical device, and the communication device and the antenna are also connected with the electrical device so as to realize the intelligent control of the electrical device.

In the above-mentioned technical solution, the power cord at least includes a power live wire and a power zero line.

In the technical solution, on the one hand, the power cord is a 3PIN power cord and includes the power live wire, the power zero line and the power ground line; and on the other hand, the power cord is a 2PIN power cord and includes the power live wire and the power zero line. Different structures of the power cord can satisfy different needs of the user, and thus the application range is wide.

One embodiment of the present disclosure, the present disclosure provides a power cord structure for an electrical device, including: a power cord plug; and a cable component connected with the power cord plug; and the power cord plug includes: a shell; a communication device arranged in the shell; and a power supply connecting terminal connected with the shell and located below the shell, and the shell and the power supply connecting terminal are formed into a rubber power cord plug by injection molding.

According to the power cord structure provided by the present disclosure, the communication device is arranged in the shell of the power cord plug and is injection molded with the power supply connecting terminal in an overall rubber coating manner, so the power cord plug is of an integrated sealed structure, then the communication device can be far away from the electrical device, in this case, the communication ability of the communication device will not be shielded by the metal shell of the electrical device, and will not be affected by the motor, the circuit board, the coils, the magnetron and other factors in the electrical device, or affected by the high temperature caused by the operation of the equipment, accordingly the communication device works in a good environment, and the working reliability and stability of the communication device are guaranteed; further, as the communication device is arranged in the shell, a fixing role is played on the one hand; on the other hand, as the communication device is arranged in the shell, in a rubber injection molding process together with the power supply connecting terminal, the high temperature in the injection molding process can be isolated to protect the communication device; and still on the other hand, since the communication device is arranged in the shell, and the power supply connecting terminal is arranged at the outside of the shell and is connected with the shell, the communication device and the power supply connecting terminal are isolated from each other by the shell, thereby avoiding the mutual interference of strong current and weak current, and improving the overall stability and reliability of the power cord structure. Further, since the shell provided with the communication device and the power supply connecting terminal are injection molded together, the power cord plug is of a sealed structure on the whole, thereby effectively guaranteeing the fixation of the communication device, preventing the interruption of communication signals caused by drop and disconnection and improving the user experience, moreover damage caused by water inflow and other problems can also be prevented, so that the communication device, the antenna and the like in the power cord plug are fully protected, and the service lives are prolonged; meanwhile, the integrated injection molding structure can be directly formed by injection molding during processing without being assembled, thereby being convenient to process, and thus the processing cost is reduced; in addition, the integrated sealed structure can also prevent current leakage in use, thereby protecting the safety of the user; and further, since the communication device is arranged in the power cord plug, no additional size is added to the electrical device, thereby guaranteeing the beauty of the overall appearance, guaranteeing convenience for carrying and improving the user experience.

In addition, the power cord structure in the above-mentioned embodiment provided by the present disclosure can further have the following additional technical features:

In the above-mentioned technical solution, the cable component includes: a power cord connected with the power supply connecting terminal; and a signal line connected with the communication device, and a metal foil is arranged in the signal line; and a rubber layer is arranged between the power cord and the signal line for insulating.

In the technical solution, the cable component of the power cord structure is connected with the power cord plug, the cable component includes the power cord for connecting the electrical device so as to supply power to the electrical device; the cable component further includes the signal line, the signal line is connected with the communication device, so that the electrical device is connected with the network or interconnected with other electrical device through the communication device to perform data transmission so as to realize the intelligent control of the electrical device. Further, the metal foil is arranged in the signal line for shielding external shielding signals and guaranteeing the communication quality; and the rubber layer is arranged between the power cord and the signal line to prevent the AC strong current of the power cord from generating electromagnetic interference to the signal line.

In any one of the above-mentioned technical solutions, the cable component is of an integrated structure, and rubber coats at the outside of the power cord and the signal line.

In the technical solution, the cable component is set as an integrated external rubber coating structure, thereby improving the safety of use, guaranteeing the beauty of the overall appearance, ensuring convenience for carrying and improving the user experience.

In any one of the above-mentioned technical solutions, the shell includes: a first cover body; and a second cover body, and the second cover body is matched with the first cover body, a hollow cavity is formed after the first cover body and the second cover body are mounted, and the communication device is arranged in the cavity.

In the technical solution, the shell is set as the upper and lower cover body structure, and the communication device is arranged in the hollow cavity that is formed after the upper cover body and the lower cover body are coordinated, thereby protecting the communication device and avoiding the drop or the influence of external factors on the one hand; and on the other hand, the hollow cavity is greater than the size of the communication device, so a part of gap is reserved for the communication device, which is beneficial for the communication device to transmit and receive signals, improves the working stability of the communication device and improves the user experience.

In any one of the above-mentioned technical solutions, a connection part is arranged on one of one side of the second cover body facing to the power supply connecting terminal and the power supply connecting terminal, a mounting part matched with the connection part is arranged on the other one of one side of the second cover body facing to the power supply connecting terminal and the power supply connecting terminal, and the shell and the power supply connecting terminal are connected by the coordination of the connection part and the mounting part.

In the technical solution, the connection part and the mounting part are arranged on the shell and the power supply connecting terminal to connect the shell and the power supply connecting terminal together, which is beneficial for the overall injection molding of the power cord plug, avoids the malposition or drop between the shell and the power supply connecting terminal and improves the production efficiency.

In any one of the above-mentioned technical solutions, the connection part is a buckle, and the mounting part is a slot.

In the technical solution, the connection between the shell and the power supply connecting terminal is realized by the coordination of the buckle and the slot, thereby being simple in structure and convenient to operate; and further, the shell and the power supply connecting terminal can also be connected in an adhesive manner.

In any one of the above-mentioned technical solutions, the shell is a plastic shell or a rubber shell.

In the technical solution, the plastic shell or the rubber shell is deployed to effectively isolate the high temperature produced in the injection molding process of the power cord plug so as to protect the communication device; meanwhile, the plastic shell or the rubber shell facilitates the reception and transmission of the signals of the communication device, avoids the influence to the reception and transmission of the signals and guarantees the communication quality of the communication device.

In any one of the above-mentioned technical solutions, the power cord structure further includes: a protective sheath sheathed on the communication device for protecting the communication device.

In the technical solution, the communication device is sheathed in the protective sheath, and due to different temperatures and pressures of different injection molding processes, in order to protect the communication device from being damaged in the injection molding process, the assorted protective sheath can be selected to protect the communication device in the injection molding process, thereby guaranteeing the reliability of the quality of the produced power cord plug.

In one embodiment, the communication device is a wireless communication device; and the wireless communication device includes at least one of the following devices: a wifi device, a Bluetooth device and an infrared device.

In one embodiment, the communication device adopts wireless communication and is cooperatively used with the antenna, so that the user can realize the remote control of the electrical device through wireless equipment, and the user can not only conveniently control the electrical device that is difficult to touch, but also can simultaneously operate multiple pieces of electrical device having wireless communication functions at one position, thereby saving time and improving the user experience. Further, the wireless communication device is a communication device having complete functions, and the wifi device can realize the network access control of the electrical device, and the user can operate the electrical device even at outdoors, thereby helping the user to make full use of time; the Bluetooth device can perform data transmission with the electrical device indoors; and the infrared device can be used for remotely controlling the electrical device, so the control of the household appliance is more convenient, and the infrared device can also be used for thermal imaging so as to be adapted to the working demands of electrical device. The wireless communication device having complete functions can satisfy comprehensive needs of the user for all kinds of electrical device, thereby improving the application range of the power cord plug.

One embodiment of the present disclosure, an electrical device is further provided, including: the power cord plug in any one of the above-mentioned technical solutions; or the cable in any one of the above-mentioned technical solutions; or the power cord structure in any one of the above-mentioned technical solutions.

The electrical device provided by the present disclosure includes the power cord plug in any one of the above-mentioned technical solutions, the cable in any one of the above-mentioned technical solutions or the power cord structure in any one of the above-mentioned technical solutions, the communication device and the antenna can be hermetically arranged in the power cord plug and are far away from the electrical device, so the communication ability of the communication device will not be shielded by the metal shell of the electrical device, and will not be affected by the motor, the circuit board, the coils, the magnetron and other factors in the electrical device, or affected by the high temperature caused by the operation of the equipment, accordingly the communication device or the antenna works in a good environment, and the working reliability and stability of the communication device are guaranteed; meanwhile, by means of the inner space of the shell of the power cord plug, no additional size is added to the electrical device, thereby guaranteeing the beauty of the overall appearance, guaranteeing convenience for carrying and improving the user experience; meanwhile, the communication device having complete functions can satisfy comprehensive needs of the user for all kinds of electrical device, thereby improving the application range of the power cord plug.

Further, the outside of the power cords and the data lines is coated with the insulating layer respectively, then an insulating layer coats at the outside of the power cords and the data lines, which have been respectively coated with the first insulating layer and the second insulating layer, as the power cords and the data lines are deployed in the same cable, the circuit layout of the electrical device can be simplified, meanwhile the power cords and the data lines are respectively coated with the insulating layer, so there are enough gaps between the power cords and the data lines to separate strong wires from weak wires, the electrical conduction between different circuits can be cut off to guarantee the safety of use, and the interference of the power cords to the data lines can also be avoided. Further, as the communication device is arranged at the outside of the electrical device, the working reliability and stability of the communication device are guaranteed, and the beauty of the overall appearance of the electrical device is guaranteed.

Further, the communication device and/or the antenna are/is singly designed on the position of the power cord plug, so the problems of shielding, high temperature, interference, beauty and the like of the communication device can be solved. Due to the power cord connector, the power cord (including the conducting wire) is not fixed to the electrical device, but is connected with the electrical device by adopting a pluggable interface form, the detachable power cord is more convenient for the movement of the electrical device and can also protect the connecting site of the power cord and the electrical device from being damaged in a carrying process, meanwhile, when the power cord is faulty and may not be maintained, only the power cord is replaced, and the electrical device can be used continuously.

In the above-mentioned technical solution, the electrical device is a household appliance, including: a microwave oven, a microwave oven, an oven and a water heater.

In the technical solution, the power cord plug or the power cord structure is applied to the microwave oven, the oven and the water heater, the user can conveniently and remotely control these household appliances, including, but not limited to, opening and closing the household appliances, setting expected values, adjusting operation modes and the like, and can also transmit menus to the microwave oven, the microwave oven and the oven for automatic cooking.

Embodiments of the present disclosure will become apparent from the following description, or may be learned by the practice of the present disclosure.

### BRIEF DESCRIPTION OF THE DRAWINGS

Embodiments of the present disclosure will become apparent and understandable from the following description of the embodiments in conjunction with the accompanying drawings:

FIG. 1 is a schematic diagram of a power cord structure in the first embodiment of the present disclosure;

FIG. 2 is a structural schematic diagram of a cable in the second embodiment of the present disclosure;

FIG. 3 is a structural schematic diagram of a cable in the third embodiment of the present disclosure;

FIG. 4 is a structural schematic diagram of a cross section of a cable in the fourth embodiment of the present disclosure;

FIG. 5 is a schematic diagram of a power cord plug in the fifth embodiment of the present disclosure;

FIG. 6 is a schematic diagram of a power cord structure in the sixth embodiment of the present disclosure;

FIG. 7 is a schematic diagram of a power cord structure in the seventh embodiment of the present disclosure;

FIG. 8 is a schematic diagram of a power cord structure in the eighth embodiment of the present disclosure;

FIG. 9 is a structural schematic diagram of a power cord plug in the ninth embodiment of the present disclosure;

FIG. 10 is a schematic diagram of a power cord structure in the tenth embodiment of the present disclosure;

FIG. 11 shows an exploded view of the power cord plug in the embedment as shown in FIG. 10.

The corresponding relationship between reference signs in FIG. 1 to FIG. 11 and component names is as follows:

1: power cord structure, 10: power cord plug, 102: shell, 104: communication device, 106: antenna, 112: cover body, 12: power cord connector, 122: power cord interface, 124: data line interface 1022: first cover body, 1024: second cover body, 20: cable, 22: power cord, 202: power live wire, 204: power zero line, 206: power ground line, 220: insulating layer, 222: first insulating layer, 224: second insulating layer, 226: third insulating layer, 24: signal line, 26: conducting wire, 28: data line, and 300: power supply connecting terminal.

### DETAILED DESCRIPTION OF THE EMBODIMENTS

Details are set forth in the following description so as to fully understand the present disclosure, but the present disclosure may also be implemented in other ways other than those described herein, and thus the protection scope of the present disclosure is not limited to the embodiments disclosed below.

The power cord plug and the power cord structure according to some embodiments of the present disclosure will be described below with reference to FIG. 1 to FIG. 11.

As shown in FIG. 1, embodiment of the present disclosure provides a power cord plug 10, including: a shell 102, a communication device 104 arranged in the shell 102, and an antenna 106 arranged in the shell 102 and connected with the communication device 104 for enabling the communication device 104 to receive and send signals.

According to the power cord plug 10 provided by the present disclosure, as the communication device 104 is arranged in the shell 102 of the power cord plug 10, the communication device 104 can be far away from the electrical device, so the communication ability of the communication device 104 will not be shielded by the metal shell of the electrical device, and will not be affected by a motor, a circuit board, coils, a magnetron and the like in the electrical device, or affected by the high temperature caused by the operation of the equipment, accordingly the communication device 104 works in a good environment, and the working reliability and stability of the communication device 104 are guaranteed; moreover, the antenna 106 is arranged in the shell 102 and is connected with the communication device 104 for enabling the communication device 104 to receive and send signals, so the connection path between the communication device 104 and the antenna 106 can be shortened, signal transmission is benefited, and the antenna 106 is protected from being damaged easily, thereby improving the working reliability; meanwhile, by means of the inner space of the shell 102 of the power cord plug 10, no additional size is added to the electrical device, thereby guaranteeing the beauty of the overall appearance, guaranteeing convenience for carrying and improving the user experience.

In an embodiment of the present disclosure, the power cord plug further includes: a conducting wire 26, one end of the conducting wire 26 is connected with the communication device 104, and the other end of the conducting wire is connected with the electrical device.

In the embodiment, the conducting wire 26 connects the communication device 104 in the power cord plug 10 with the electrical device to perform data transmission, and the electrical device is connected with the network or interconnected with other electrical device through the communication device 104 so as to realize the intelligent control of the electrical device.

In an embodiment of the present disclosure, the power cord plug 10 is of an integrated sealed structure.

In the embodiment, the power cord plug 10 adopts the plastic integrated sealed structure, and the communication device 104 at the middle may not be detached, thereby effectively guaranteeing the fixation of the communication device 104, preventing the interruption of communication signals caused by drop and disconnection and improving the user experience, moreover damage caused by water inflow and other problems can also be prevented, so that the communication device 104, the antenna 106 and the like in the power cord plug 10 are fully protected, and the service lives are prolonged; meanwhile, the plastic integrated structure can be directly formed by injection molding during processing without being assembled, thereby being convenient to process, and thus the processing cost is reduced; and in addition, the integrated sealed structure can also prevent current leakage in use, thereby protecting the safety of the user.

In an embodiment of the present disclosure, the power cord plug further includes: a protective sheath (not shown in the figures) sheathed on the communication device 104 for protecting the communication device 104.

In the embodiment, the communication device 104 is sheathed in the protective sheath, and due to different temperatures and pressures of different injection molding processes, in order to protect the communication device 104 from being damaged in an injection molding process, the assorted protective sheath can be selected to protect the communication device 104 in the injection molding process, thereby guaranteeing the reliability of the quality of the produced power cord plug 10.

In an embodiment of the present disclosure, the communication device 104 is a wireless communication device 104.

In the embodiment, the communication device 104 adopts wireless communication and is cooperatively used with the antenna 106, so that the user can realize the remote control of the electrical device through wireless equipment, and the user can not only conveniently control the electrical device that is difficult to touch, but also can simultaneously operate multiple pieces of electrical device having wireless communication functions at one position, thereby saving time and improving the user experience.

In an embodiment of the present disclosure, the wireless communication device 104 includes at least one of the following devices: a wifi device, a Bluetooth device and an infrared device.

In the embodiment, the wireless communication device 104 is a communication device 104 having complete functions, and the wifi device can realize the network access control of the electrical device, and the user can operate the electrical device even at outdoors, thereby helping the user to make full use of time, for example, the user firstly opens a water heater before arriving at home and adjusts the water heater to a certain temperature, and thus the user can use the water heater without waiting; the Bluetooth device can perform data transmission with the electrical device indoors, for example, transmit a menu to a microwave oven to realize automatic cooking; and the infrared device can be used for remotely controlling the electrical device, so the control of the household appliance is more convenient, for example, such household appliances that are difficult to touch as an electric heater mounted on the ceiling can be remotely controlled by wireless equipment conveniently, thereby avoiding accidental injury of the user, and the infrared device can also be used for thermal imaging so as to be adapted to the working demands of electrical device. The wireless communication device 104 having complete functions can satisfy comprehensive needs of the user for all kinds of electrical device, thereby improving the application range of the power cord plug 10.

As shown in FIG. 1, embodiment of the present disclosure provides a power cord structure 1 for an electrical device, including: the power cord plug 10 in any one of the above-mentioned technical solutions; and a power cord 22 connected with the power cord plug 10.

The power cord structure 1 provided by the present disclosure includes the power cord plug 10 in any one of the above-mentioned technical solutions and the power cord 22 connected with the power cord plug, therefore the power cord structure has all the beneficial effects of the power cord plug 10, and the power cord plug 10 is connected with the electrical device through the power cord 22 so as to guarantee the power supply and the connection between the communication device 104 and the electrical device.

In an embodiment of the present disclosure, the conducting wire 26 and the power cord 22 are of an integrated structure, and the conducting wire 26 is integrated in the power cord 22.

In the embodiment, the conducting wire 26 for connecting the communication device 104 with the electrical device is integrated with the power cord 22, so that the connecting circuits of the communication device 104 and the power supply with the electrical device are merged, the circuit layout is more neat, the mounting is convenient, meanwhile, rubber coating of the power cord 22 protects the conducting wire 26, thereby not only prolonging the service life of the conducting wire 26, but also guaranteeing the safety of the user in daily use.

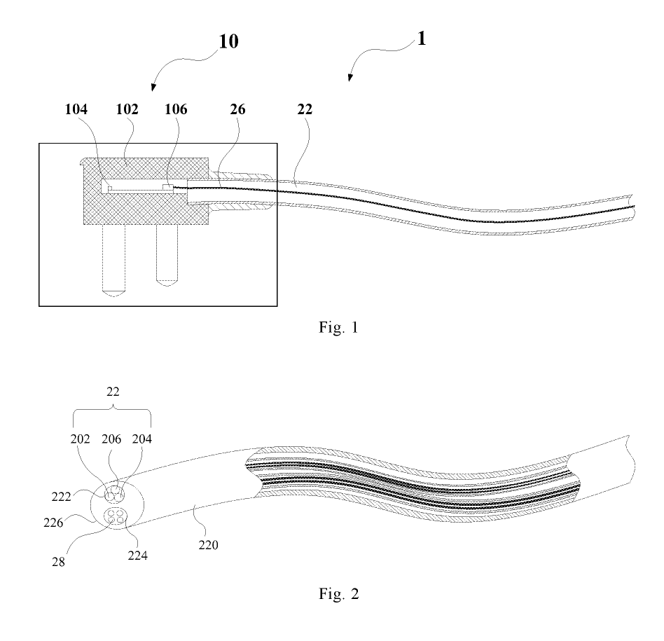

As shown in FIG. 2 to FIG. 4, embodiment of the present disclosure provides a cable 20, including: at least two power cords 22 coated with a first insulating layer 222; at least one data line 28 coated with a second insulating layer 224; and a third insulating layer 226, and the third insulating layer 226 coating at the outside of the power cords 22 and the data lines 28, which have been respectively coated with the first insulating layer 222 and the second insulating layer 224.

The cable 20 provided by the present disclosure includes at least two power cords 22 for providing electric power to the electrical device, and at least one data line 28 for connecting the communication device 104 with the electrical device and transmitting signals, and the number of the data lines 28 can be determined according to needs. The outside of the power cords 22 and the data lines 28 is coated with the insulating layer 220 respectively, then an insulating layer 220 coats at the outside of the power cords 22 and the data lines 28, which have been respectively coated with the first insulating layer 222 and the second insulating layer 224, as the power cords 22 and the data lines 28 are deployed in the same cable 20, the circuit layout of the electrical device can be simplified, meanwhile the power cords 22 and the data lines 28 are respectively coated with the insulating layer 220, so there are enough gaps between the data lines 28 and the power cords 22 to separate strong wires from weak wires, the electrical conduction between different circuits can be cut off to guarantee the safety of use, and the interference of the power cords 22 to the data lines 28 can also be avoided.

In addition, the cable 20 in the above-mentioned embodiment provided by the present disclosure can further have the following additional technical features:

In an embodiment of the present disclosure, the outside of each data line 28 is coated with the insulating layer 220.

In the embodiment, as the outside of each data line 28 is coated with the insulating layer 220, the electrical conduction and mutual interference between different data lines 28 can be isolated.

In an embodiment of the present disclosure, four data lines 28 are set, and the outside of the entirety of the four data lines 28 is coated with a shielding layer .

In the embodiment, the outside of the entirety of the data lines 28 is coated with the shielding layer, so there are enough gaps between the data lines 28 and the power cords 22 to ensure that the data lines 28 are not interfered by the strong current of the power cords 22 and to ensure the reliability and stability of signal transmission of the data lines 28.

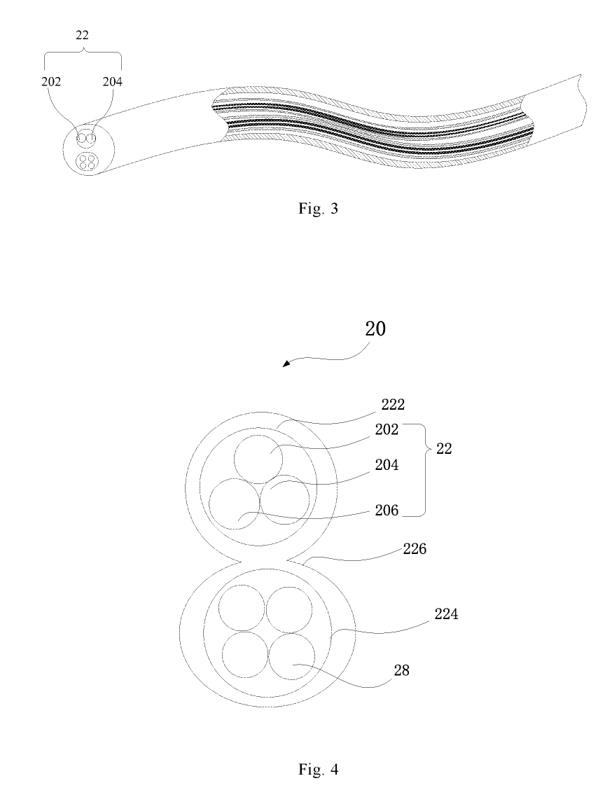

In an embodiment of the present disclosure, as shown in FIG. 3, the power cord 22 includes a power live wire 202 and a power zero line 204; and the outside of the power live wire 202 and the power zero line 204 is coated singly with an insulating layer 220.

In the embodiment, the power live wire 202 and the power zero line 204 can satisfy the needs of daily power supply of the electrical device, and the outside of the power live wire 202 and the power zero line 204 is coated with the insulating layer 220 so as to isolate the electrical conduction, prevent fire accidents of the electrical device caused by the short circuit of the power live wire and the power zero line, and protect the personal and property safety.

In an embodiment of the present disclosure, as shown in FIG. 4, the power cord 22 further includes a power ground line 206, and the outside of the power ground line 206 is coated with an insulating layer 220.

In the embodiment, the power ground line 206 can satisfy the safety demands of high-power electrical device in a use process and form ground protection. As outside of the power ground line is coated with the insulating layer 220, current leakage protection can be formed.

In an embodiment of the present disclosure, the cross section of the cable 20 is shaped like a circle or a FIG. 8.

In the embodiment, in the technical solution, as shown in FIG. 2 to FIG. 4, after the power cords 22 and the data lines 28 are integrally coated with rubber, the cross section can be shaped like a circle, the FIG. 8, a rectangle and other shapes depending on circumstances, as long as the processing is convenient and the use is comfortable.

According to the embodiment of the present disclosure, a power cord structure 1 is further provided, including: a power cord plug 10; and the cable 20 in any one of the above-mentioned technical solutions; and the power cord plug 10 is connected with the cable 20.

The power cord structure 1 provided by the embodiment of the present disclosure includes the cable 20 in any one of the above-mentioned technical solutions, thereby having all the beneficial effects of the cable 20.

In an embodiment of the present disclosure, the power cord structure further includes a communication device 104 arranged in the power cord plug 10 and connected with the data lines 28.

In the embodiment, the communication device 104 is arranged in the power cord plug 10, and a communication signal is transmitted to the electrical device by the data lines 28, thereby realizing the network connection of the electrical device or the interconnection with other equipment, and helping the user to intelligently control the electrical device.

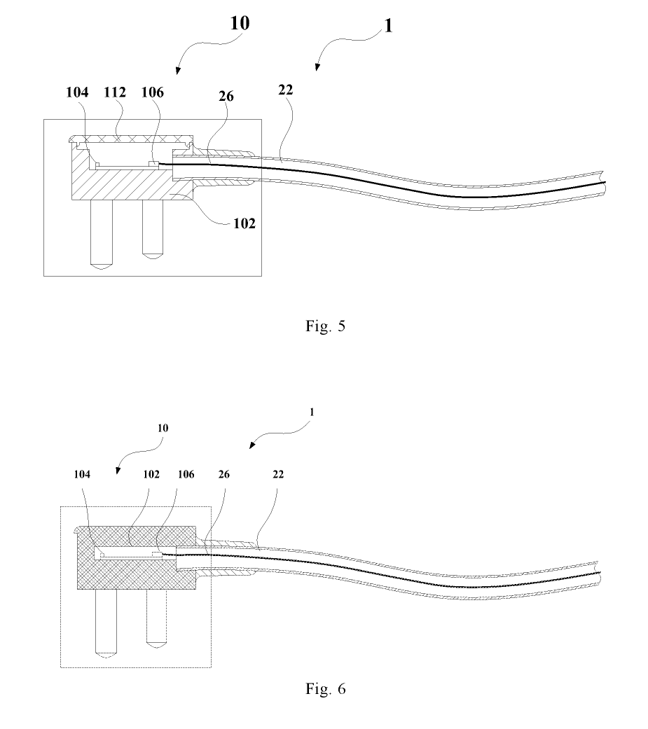

As shown in FIG. 5, the embodiment of the present disclosure provides a power cord plug 10 including: a shell 102; a communication device 104 arranged in the shell 102; and a cover body arranged on the shell 102, and the cover body is detachably mounted on the shell 102.

In the technical solution, as the communication device 104 is arranged in the shell 102 of the power cord plug 10, the communication device 104 can be far away from the electrical device, so the communication ability of the communication device 104 will not be shielded by the metal shell of the electrical device, and will not be affected by the motor, the circuit board, the coils, the magnetron and the like in the electrical device, or affected by the high temperature caused by the operation of the equipment, accordingly the communication device 104 works in a good environment, and the working reliability and stability of the communication device 104 are guaranteed; meanwhile, by means of the inner space of the shell 102 of the power cord plug 10, no additional size is added to the electrical device, thereby guaranteeing the beauty of the overall appearance, guaranteeing convenience for carrying and improving the user experience; and moreover, as the cover body 112 is arranged on the shell 102, and the cover body 112 is detachably mounted on the shell 102, when a component in the shell 102 is damaged, troubleshooting is facilitated for maintenance and component replacement.

In an embodiment of the present disclosure, the power cord plug further includes: an antenna 106 arranged in the shell 102 and connected with the communication device 104 for enabling the communication device 104 to receive and send signals.

In the embodiment, both the communication device 104 and the used antenna 106 are designed on the position of the power cord plug 10, thereby being able to shorten the connection path between the communication device 104 and the antenna 106 and facilitate signal transmission; meanwhile, it is avoided that additional antenna 106 portions are increased at the outside of the electrical device to increase the size of the electrical device, thereby guaranteeing the beauty and practicability of the electrical device, protecting the antenna 106 from being damaged easily and improving the working reliability of the communication device 104.

In an embodiment of the present disclosure, the power cord plug further includes: a conducting wire 26, one end of the conducting wire 26 is connected with the communication device 104, and the other end of the conducting wire is connected with the electrical device.

In the embodiment, the conducting wire 26 connects the communication device 104 in the power cord plug 10 with the electrical device to perform data transmission, and the electrical device is connected with the network or interconnected with other electrical device through the communication device 104 so as to realize the intelligent control of the electrical device.

In an embodiment of the present disclosure, a buckle is arranged on one of the shell 102 and the cover body 112, and a slot matched with the buckle is arranged on the other one of the shell 102 and the cover body 112.

In the embodiment, the cover body 112 and the shell 102 are matched through the buckle and the slot, and when the components in the shell 102 are damaged, the components are convenient to detach and install for maintenance and component replacement. In implementation, the cover body and the shell 102 can also be fixedly mounted in other manners such as screw connection, etc.

In an embodiment of the present disclosure, the communication device 104 is a wireless communication device 104.

In the embodiment, the communication device 104 adopts wireless communication and is cooperatively used with the antenna 106, so that the user can realize the remote control of the electrical device through wireless equipment, and the user can not only conveniently control the electrical device that is difficult to touch, but also can simultaneously operate multiple pieces of electrical device having wireless communication functions at one position, thereby saving time and improving the user experience.

In an embodiment of the present disclosure, the wireless communication device 104 includes at least one of the following devices: a wifi device, a Bluetooth device and an infrared device.

In the embodiment, the wireless communication device 104 is a communication device 104 having complete functions, and the wifi device can realize the network access control of the electrical device, and the user can operate the electrical device even at outdoors, thereby helping the user to make full use of time, for example, the user firstly opens a water heater before arriving at home and adjusts the water heater to a certain temperature, and thus the user can use the water heater without waiting; the Bluetooth device can perform data transmission with the electrical device indoors, for example, transmit a menu to a microwave oven to realize automatic cooking; and the infrared device can be used for remotely controlling the electrical device, so the control of the household appliance is more convenient, for example, such household appliances that are difficult to touch as an electric heater mounted on the ceiling can be remotely controlled by wireless equipment conveniently, thereby avoiding accidental injury of the user, and the infrared device can also be used for thermal imaging so as to be adapted to the working demands of electrical device. The wireless communication device 104 having complete functions can satisfy comprehensive needs of the user for all kinds of electrical device, thereby improving the application range of the power cord plug 10.

As shown in FIG. 5, the embodiment of the present disclosure provides a power cord structure 1 for an electrical device, including: the power cord plug 10 in any one of the above-mentioned technical solutions; and a power cord 22 connected with the power cord plug 10.

The power cord structure 1 provided by the present disclosure includes the power cord plug 10 in any one of the above-mentioned technical solutions and the power cord 22 connected with the power cord plug, apparently, the power cord structure has the features of the power cord plug 10, and the power cord plug 10 is connected with the electrical device through the power cord 22 so as to guarantee the power supply and the connection between the communication device 104 and the electrical device.

In an embodiment of the present disclosure, the conducting wire 26 and the power cord 22 are of an integrated structure, and the conducting wire 26 is integrated in the power cord 22.

In the embodiment, the conducting wire 26 for connecting the communication device 104 with the electrical device is integrated with the power cord 22, so that the connecting circuits of the communication device 104 and the power supply with the electrical device are merged, the circuit layout is more neat, the mounting is more convenient, meanwhile the rubber coating structure of the power cord 22 protects the conducting wire 26, thereby not only prolonging the service life of the conducting wire 26, but also guaranteeing the safety of the user in daily use.

As shown in FIG. 6, the embodiment of the present disclosure provides a power cord plug 10, including: a shell 102; and an antenna 106 arranged in the shell 102.

According to the power cord plug 10 provided by the present disclosure, as the antenna 106 is arranged in the shell 102, the antenna 106 does not need to be exposed to the outside, so that the antenna 106 can be protected from being damaged easily, and the antenna 106 can work in a good environment, thereby guaranteeing the working reliability and stability of the antenna 106; meanwhile, by means of the inner space of the shell 102 of the power cord plug 10, no additional antenna 106 portion is added to the electrical device, thereby guaranteeing the beauty of the overall appearance, guaranteeing convenience for carrying and improving the user experience.

In an embodiment of the present disclosure, the power cord plug further includes: a communication device 104 arranged in the shell 102 and connected with the antenna 106.

In the embodiment, the communication device 104 is arranged in the power cord plug 10, thereby not only being able to shorten the connection path between the communication device 104 and the antenna 106 and facilitate signal transmission, but also avoiding increasing additional communication devices 104 and antenna 106 portions at the outside of the electrical device to increase the size of the electrical device, and guaranteeing the appearance consistency, beauty and practicability of the electrical device; meanwhile, as the communication device 104 is arranged in the shell 102, the communication device 104 can be far away from the electrical device, so the communication ability of the communication device 104 will not be shielded by the metal shell of the electrical device, and will not be affected by the motor, the circuit board, the coils, the magnetron and other factors in the electrical device, or affected by the high temperature caused by the operation of the equipment, accordingly the communication device 104 works in a good environment, and the working reliability and stability of the communication device 104 are guaranteed.

Further, for example, the microwave oven includes the communication device 104, if the communication device 104 works at 2.412 GHz to 2.472 GHz, and the microwave center frequency of the microwave oven is 2.45 GHz, then the microwave oven will generate same frequency interference on the communication device 104, the communication device 104 is arranged in the shell 102 of the communication device located at the outside of the microwave oven, so the communication device 104 is far away from the microwave oven, the same frequency interference of the communication device 104 generated by the microwave oven is effectively reduced, or the microwave oven may not interfere with the communication device, therefore the communication ability of the communication device 104 will not be affected by the motor, the circuit board, the coils, the magnetron and other factors in the electrical device, and the satisfaction degree of use of the user is improved. Further, for example, the water heater includes the communication device 104, the shell of the water heater is generally of a full-metal sealed structure, if the communication device 104 is designed in the water heater, the communication device 104 will be shielded by the metal and may not work, the communication device 104 is arranged in the shell 102 of the communication device located at the outside of the water heater, so the communication device 104 is far away from the water heater, and the interference of the communication device 104 generated by a metal outer wall of the water heater is effectively avoided, therefore the communication ability of the communication device 104 will not be shielded by the metal shell of the electrical device, and the satisfaction degree of use of the user is improved.

Further, for example, an oven includes the communication device 104, the majority of the working temperatures of the oven are higher than 200 degrees centigrade, the oven continuously dissipates heat, so the surrounding of the shell of the oven is a high temperature area, which does not satisfy the temperature needs for the working of the communication device 104, thereby affecting the working effect of the communication device 104, as the communication device 104 is arranged in the shell 102 of the communication device located at the outside of the oven, the communication device 104 works in a good environment, and the working reliability and stability of the communication device 104 are guaranteed. Further, for example, an air conditioner includes the communication device 104, and the antenna 106 connected with the communication device 104 is led to the outside of the air conditioner, thereby affecting the overall reliability and beauty of the air conditioner, the communication device 104 is arranged in the shell 102 of the communication device located at the outside of the air conditioner so as to utilize the inner space of the shell 102 of the communication device, thereby increasing no additional size of the electrical device, guaranteeing the beauty of the overall appearance, being higher in practicability and improving the satisfaction degree of use of the user.

In an embodiment of the present disclosure, the power cord plug further includes: a conducting wire 26, one end of the conducting wire 26 is connected with the communication device 104 or the antenna 106, and the other end of the conducting wire is connected with the electrical device.

In the embodiment, on the one hand, when both the communication device 104 and the antenna 106 are arranged in the shell 102, the antenna 106 is connected with the communication device 104, and the antenna 106 quickly transmits a received signal to the communication device 104 and transmits the signal to the electrical device through the conducting wire 26 so as to realize the intelligent control of the electrical device.

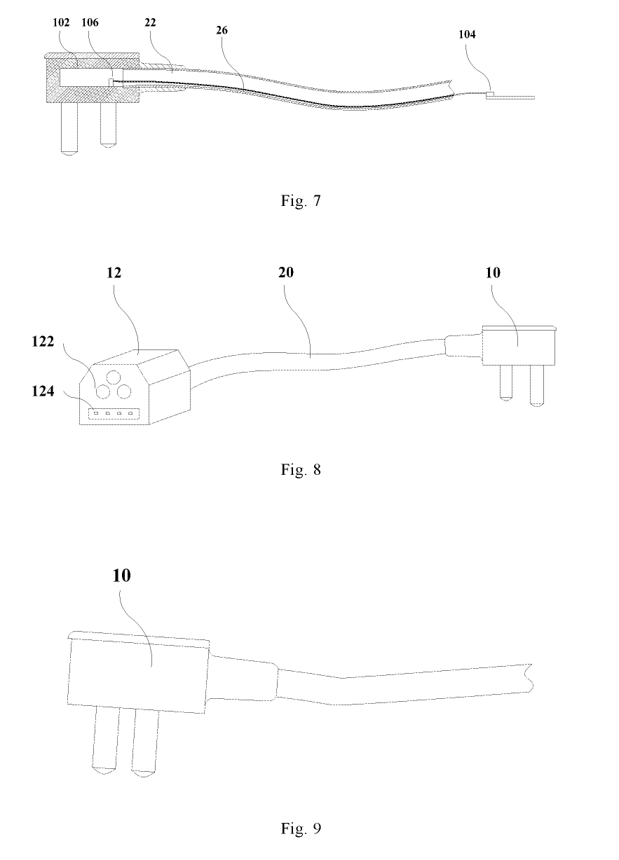

On the other hand, as shown in FIG. 7, the communication device 104 and the antenna 106 are not located on the same position, the communication device 104 can be designed in the electrical device or on the shell, the antenna 106 of the communication device 104 is led out by the conducting wire 26 and is designed on the position of the power cord plug 22, and the antenna 106 transmits the signal to the communication device 104 of the electrical device through the conducting wire 26 after receiving the signal so as to realize the intelligent control of the electrical device.

In an embodiment of the present disclosure, the power cord plug 10 is of an integrated sealed structure.

In the embodiment, the power cord plug 10 adopts the plastic integrated rubber coating sealed structure, and the communication device 104 or the antenna 106 located in the power cord plug 10 may not be detached, thereby effectively guaranteeing the fixation of the communication device 104 or the antenna 106, preventing the interruption of communication signals caused by drop and disconnection and improving the user experience, moreover damage caused by water inflow and other problems can also be prevented, so that the communication device 104 or the antenna 106 and the like in the power cord plug 10 are fully protected, and the service lives are prolonged; meanwhile, the plastic integrated structure can be directly formed by injection molding during processing without being assembled, thereby being convenient to process, and thus the processing cost is reduced; and in addition, the integrated sealed structure can also prevent current leakage in use, and thus the safety of the user is protected.

In an embodiment of the present disclosure, the shell 102 is detachably mounted on the power cord plug 10.

In the embodiment, the shell 102 is mounted on the power cord plug and can be detached, thereby being convenient to troubleshoot for maintenance and component replacement.

In an embodiment of the present disclosure, the power cord plug further includes: a cover body, and the cover body is detachably arranged on the shell 102.

In the embodiment, as the cover body is arranged on the shell 102, and the cover body is detachably mounted on the shell 102, when any one of the communication device 104, the antenna 106 and the conducting wire 26 in the shell 102 is damaged, troubleshooting is facilitated for maintenance and component replacement.

In an embodiment of the present disclosure, the power cord plug further includes: a protective sheath sheathed on the communication device 104 or the antenna 106 for protecting the communication device 104 or the antenna 106.

In the embodiment, on the one hand, when the power cord plug 10 is of the integrated sealed structure, due to different temperatures and pressures of different injection molding processes, in order to protect the communication device 104 or the antenna 106 from being damaged in the injection molding process, the assorted protective sheath can be selected to protect the communication device 104 or the antenna 106 in the injection molding process, thereby guaranteeing the reliability of the quality of the produced power cord plug 10. On the other hand, when the power cord plug is of a detachable structure, the communication device 104 or the antenna 106 in the power cord plug 10 may be exposed to the outside due to fault maintenance or accidental opening, therefore the protective sheath can protect the communication device 104 or the antenna 106 from being damaged at this time.

In an embodiment of the present disclosure, the communication device 104 is a wireless communication device 104.

In the embodiment, the communication device 104 adopts wireless communication, so that the user can realize the remote control of the electrical device through wireless equipment, and the user can not only conveniently control the electrical device that is difficult to touch, but also can simultaneously operate multiple pieces of electrical device having wireless communication functions at one position, thereby saving time and improving the user experience.

In an embodiment of the present disclosure, the wireless communication device 104 includes at least one of the following devices: a wifi device, a Bluetooth device and an infrared device.

In the embodiment, the wireless communication device 104 is a communication device 104 having complete functions, and the wifi device can realize the network access control of the electrical device; the Bluetooth device can perform data transmission with the electrical device indoors; and the infrared device can be used for remotely controlling the electrical device, so the control of the household appliance is more convenient, and the infrared device can also be used for thermal imaging so as to be adapted to the working demands of electrical device. The wireless communication device 104 having complete functions can satisfy comprehensive needs of the user for all kinds of electrical device, thereby improving the application range of the power cord plug 10.

As shown in FIG. 8, the embodiment of the eighth embodiment of the present disclosure further provides a power cord structure 1 for an electrical device, including: the power cord plug 10 in any one of the above-mentioned technical solutions; a power cord connector 12; and a power cord 22, and one end of the power cord 22 is connected with the power cord plug 10, and the other end of the power cord 22 is connected with the power cord connector 12.

The power cord structure 1 provided by the embodiment of the eighth embodiment of the present disclosure includes the power cord plug 10 in any one of the above-mentioned technical solutions and the power cord 22 connected with the power cord plug, therefore the power cord structure has all the beneficial effects of the power cord plug 10. The communication device 104 or the antenna 106 is designed on the position of the power cord plug 10, so the problems of shielding, high temperature, interference, beauty and the like of the communication device 104 can be solved. Due to the power cord 22 connector 12, the power cord 22 (including the conducting wire 26) is not fixed to the electrical device, but is connected with the electrical device by adopting a pluggable interface form, the detachable power cord 22 is more convenient for the movement of the electrical device and can also protect the connecting site of the power cord 22 and the electrical device from being damaged in a carrying process, meanwhile, when the power cord 22 is faulty and may not be maintained, only the power cord 22 is replaced, and the electrical device can be used continuously.

In an embodiment of the present disclosure, as shown in FIG. 8, the conducting wire 26 and the power cord 22 are of an integrated structure, and the conducting wire 26 is integrated in the power cord 22.

In the embodiment, the conducting wire 26 for connecting the communication device 104 with the electrical device is integrated with the power cord 22, so that the connecting circuits of the communication device 104 and the power supply with the electrical device are merged, the circuit layout is more neat, meanwhile the rubber coating of the power cord 22 protects the circuits, thereby not only prolonging the service lives of the circuits, but also guaranteeing the safety of the user in daily use.

In an embodiment of the present disclosure, as shown in FIG. 8, the power cord connector 12 includes: a power cord interface 122 connected with the power cord 22; and a data line interface 124 connected with the conducting wire 26.

In the embodiment, the power cord connector is provided with the power cord interface 122 and the data line interface 124, which can be respectively connected with the power cord 22 and the conducting wire 26, therefore the power supply is connected with the electrical device through the power cord 22 to provide electric power for the electrical device, and the communication device 104 or the antenna 106 is also connected with the electrical device to transmit signals so as to realize the intelligent control of the electrical device.

In an embodiment of the present disclosure, the power cord 22 at least includes a power live wire 202 and a power zero line 204.

In the embodiment, on the one hand, as shown in FIG. 8, the power cord 22 is a 3PIN power cord 22 and includes the power live wire 202, the power zero line 204 and the power ground line 206; and on the other hand, as shown in FIG. 9, the power cord 22 is a 2PIN power cord 22 and includes the power live wire 202 and the power zero line 204. Different structures of the power cord 22 can satisfy different needs of the user, and thus the application range is wide. Different numbers of the power cord 22 interfaces 122 can satisfy different needs of the user, and thus the application range is wide. Further, there may be 4 data line 28 interfaces 124, meanwhile four conducting wires 26 are connected, further the number of the data line 28 interfaces 124 can be any number satisfying the needs, and different forms of the data line 28 interfaces 124 can satisfy different needs of the user, and thus the application range is wide.

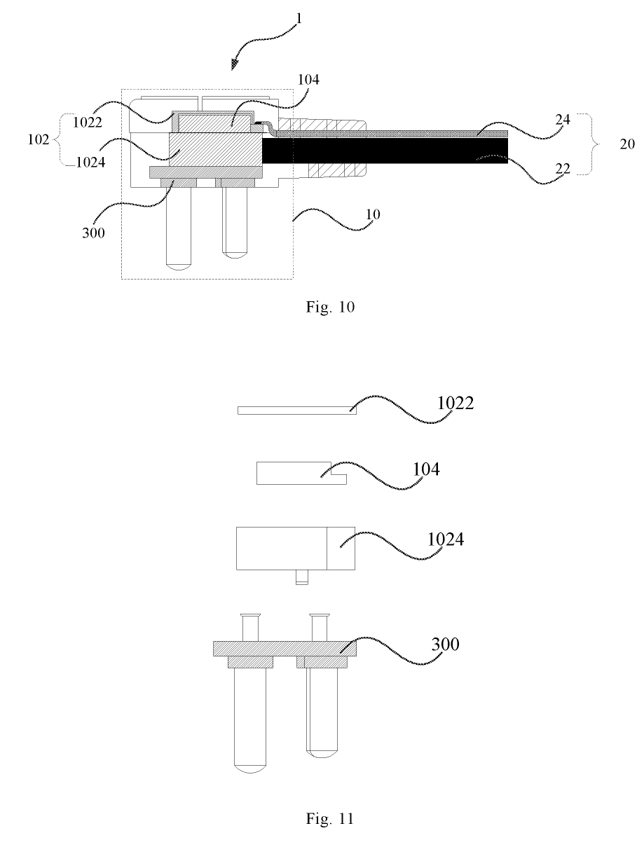

As shown in FIG. 10 and FIG. 11, the ninth embodiment of the present disclosure provides a power cord structure 1 for an electrical device, including: a power cord plug 10 and a cable 20 component, and the cable 20 component is connected with the power cord plug 10; and, as shown in FIG. 11, the power cord plug 10 includes: a shell 102; a communication device 104 arranged in the shell 102; and a power supply connecting terminal 300 connected with the shell 102 and located below the shell 102, and the shell 102 and the power supply connecting terminal 300 are formed into a rubber power cord plug 10 by injection molding.

According to the power cord structure 1 provided by the present disclosure, the communication device 104 is arranged in the shell 102 of the power cord plug 10 and is injection molded with the power supply connecting terminal 300 in an overall rubber coating manner, so the power cord plug 10 is of an integrated sealed structure, then the communication device 104 can be far away from the electrical device, in this case, the communication ability of the communication device 104 will not be shielded by the metal shell of the electrical device, and will not be affected by the motor, the circuit board, the coils, the magnetron and other factors in the electrical device, or affected by the high temperature caused by the operation of the equipment, accordingly the communication device 104 works in a good environment, and the working reliability and stability of the communication device 104 are guaranteed; further, as the communication device 104 is arranged in the shell 102, a fixing role is played on the one hand; on the other hand, as the communication device is arranged in the shell 102, in a rubber injection molding process together with the power supply connecting terminal 300, the high temperature in the injection molding process can be isolated to protect the communication device 104; and still on the other hand, since the communication device 104 is arranged in the shell 102, and the power supply connecting terminal 300 is arranged at the outside of the shell 102 and is connected with the shell 102, the communication device 104 and the power supply connecting terminal 300 are isolated from each other by the shell 102, thereby avoiding the mutual interference of strong current and weak current, and improving the overall stability and reliability of the power cord structure 1. Further, since the shell 102 provided with the communication device 104 and the power supply connecting terminal 300 are injection molded together, the power cord plug 10 is of a sealed structure on the whole, thereby effectively guaranteeing the fixation of the communication device 104, preventing the interruption of communication signals caused by drop and disconnection and improving the user experience, moreover damage caused by water inflow and other problems can also be prevented, so that the communication device 104, the antenna 106 and the like in the power cord plug 10 are fully protected, and the service lives are prolonged; meanwhile, the integrated injection molding structure can be directly formed by injection molding during processing without being assembled, thereby being convenient to process, and thus the processing cost is reduced; in addition, the integrated sealed structure can also prevent current leakage in use, thereby protecting the safety of the user; and further, since the communication device 104 is arranged in the power cord plug 10, no additional size is added to the electrical device, thereby guaranteeing the beauty of the overall appearance, guaranteeing convenience for carrying and improving the user experience.

In addition, the power cord structure 1 in the above-mentioned embodiment provided by the present disclosure can further have the following additional technical features:

In an embodiment of the present disclosure, the cable 20 component includes: a power cord 22 connected with the power supply connecting terminal 300; and a signal line 24 connected with the communication device 104, and a metal foil is arranged in the signal line 24; and and a rubber layer is arranged between the power cord 22 and the signal line 24 for insulating.

In the embodiment, the cable 20 component of the power cord structure 1 is connected with the power cord plug 10, the cable 20 component includes the power cord 22 for connecting the electrical device so as to supply power to the electrical device; the cable component further includes the signal line 24, the signal line 24 is connected with the communication device 104, so that the electrical device is connected with the network or interconnected with other electrical device through the communication device 104 to perform data transmission so as to realize the intelligent control of the electrical device. Further, the metal foil is arranged in the signal line 24 for shielding external interference signals and guaranteeing the communication quality; and the rubber layer is arranged between the power cord 22 and the signal line 24 to prevent the AC strong current of the power cord 22 from generating electromagnetic interference to the signal line 24.

In an embodiment of the present disclosure, the cable 20 component is of an integrated structure, and rubber coats at the outside of the power cord 22 and the signal line 24.

In the embodiment, the cable 20 component is set as an integrated external rubber coating structure, thereby improving the safety of use, guaranteeing the beauty of the overall appearance, ensuring convenience for carrying and improving the user experience.

In a embodiment, after the power cord 22 and the signal line 24 are separately coated with rubber, the rubber coats at the outside of the entirety, and thus the use reliability of the cable 20 component is improved.

In an embodiment of the present disclosure, the shell 102 includes: a first cover body 1022; and a second cover body 1024, and the second cover body 1024 is matched with the first cover body 1022, a hollow cavity is formed after the first cover body 1022 and the second cover body 1024 are mounted, and the communication device 104 is arranged in the cavity.

In the embodiment, the shell 102 is set as the upper and lower cover body structure, and the communication device 104 is arranged in the hollow cavity that is formed after the upper cover body and the lower cover body are coordinated, thereby protecting the communication device 104 and avoiding the drop or the influence of external factors on the one hand; and on the other hand, the hollow cavity is greater than the size of the communication device 104, so a part of gap is reserved for the communication device 104, which is beneficial for the communication device 104 to transmit and receive signals, improves the working stability of the communication device 104 and improves the user experience.

In a embodiment, an accommodation cavity is arranged on one of the first cover body 1022 and the second cover body 1024 for accommodating the communication device 104, and the space of the accommodation cavity is greater than the size of the communication device 104, thereby being beneficial for the signal reception or transmission of the communication device 104; and the first cover body 1022 and the second cover body 1024 can be connected by a buckle or a slot or in a glue adhesive manner, and is not limited to listed connection modes in a implementation process.

In an embodiment of the present disclosure, a connection part is arranged on one of one side of the second cover body 1024 facing to the power supply connecting terminal 300 and the power supply connecting terminal 300, a mounting part matched with the connection part is arranged on the other one of one side of the second cover body 1024 facing to the power supply connecting terminal 300 and the power supply connecting terminal 300, and the shell 102 and the power supply connecting terminal 300 are connected by the coordination of the connection part and the mounting part.

In the embodiment, the connection part and the mounting part are arranged on the shell 102 and the power supply connecting terminal 300 to connect the shell 102 and the power supply connecting terminal 300 together, which is beneficial for the overall injection molding of the power cord plug 10, avoids the malposition or drop between the shell 102 and the power supply connecting terminal 300 and improves the production efficiency.

In an embodiment of the present disclosure, the connection part is a buckle, and the mounting part is a slot.

In the embodiment, the connection between the shell 102 and the power supply connecting terminal 300 is realized by the coordination of the buckle and the slot, thereby being simple in structure and convenient to operate; and further, the shell 102 and the power supply connecting terminal 300 can also be connected in an adhesive manner.

In an embodiment of the present disclosure, the shell 102 is a plastic shell 102 or a rubber shell 102.

In the embodiment, the plastic shell 102 or the rubber shell 102 is deployed to effectively isolate the high temperature produced in the injection molding process of the power cord plug 10 so as to protect the communication device 104; meanwhile, the plastic shell 102 or the rubber shell 102 facilitates the reception and transmission of the signals of the communication device 104, avoids the influence to the reception and transmission of the signals and guarantees the communication quality of the communication device 104.

In an embodiment of the present disclosure, the power cord structure further includes: a protective sheath sheathed on the communication device 104 for protecting the communication device 104.

In the embodiment, the communication device 104 is sheathed in the protective sheath, and due to different temperatures and pressures of different injection molding processes, in order to protect the communication device 104 from being damaged in the injection molding process, the assorted protective sheath can be selected to protect the communication device 104 in the injection molding process, thereby guaranteeing the reliability of the quality of the produced power cord plug 10.

In any one of the above-mentioned embodiments, the communication device 104 is a wireless communication device 104; and the wireless communication device 104 includes at least one of the following devices: a wife device, a Bluetooth device and an infrared device.

In the embodiment, the communication device 104 adopts wireless communication and is cooperatively used with the antenna 106, so that the user can realize the remote control of the electrical device through wireless equipment, and the user can not only conveniently control the electrical device that is difficult to touch, but also can simultaneously operate multiple pieces of electrical device having wireless communication functions at one position, thereby saving time and improving the user experience. Further, the wireless communication device 104 is a communication device 104 having complete functions, and the wife device can realize the network access control of the electrical device, and the user can operate the electrical device even at outdoors, thereby helping the user to make full use of time; the Bluetooth device can perform data transmission with the electrical device indoors; and the infrared device can be used for remotely controlling the electrical device, so the control of the household appliance is more convenient, and the infrared device can also be used for thermal imaging so as to be adapted to the working demands of electrical device. The wireless communication device 104 having complete functions can satisfy comprehensive needs of the user for all kinds of electrical device, thereby improving the application range of the power cord plug 10.

In a embodiment, the power supply connecting terminal 300 is a three-plug terminal or a two-plug terminal, and can be selected according to the model and the type of the electrical device.

The embodiment of the present disclosure provides an electrical device, including: the power cord plug 10 in any one of the above-mentioned technical solutions; or the cable 20 in any one of the above-mentioned technical solutions; or the power cord structure 1 in any one of the above-mentioned technical solutions.

The electrical device provided by the present disclosure includes the power cord plug 10 in any one of the above-mentioned technical solutions, the cable 20 in any one of the above-mentioned technical solutions or the power cord structure 1 in any one of the above-mentioned technical solutions, the communication device 104 and the antenna 106 can be hermetically arranged in the power cord plug 10 and are far away from the electrical device, so the communication ability of the communication device 104 will not be shielded by the metal shell of the electrical device, and will not be affected by the motor, the circuit board, the coils, the magnetron and the like in the electrical device, or affected by the high temperature caused by the operation of the equipment, accordingly the communication device 104 works in a good environment, and the working reliability and stability of the communication device 104 are guaranteed; meanwhile, by means of the inner space of the shell 102 of the power cord plug 10, no additional size is added to the electrical device, thereby guaranteeing the beauty of the overall appearance, guaranteeing convenience for carrying and improving the user experience.

Meanwhile, the conducting wire 26 for connecting the communication device 104 with the electrical device is integrated with the power cord 22, so that the circuit can be simplified; and the communication device 104 having complete functions can satisfy comprehensive needs of the user for all kinds of electrical device, thereby improving the application range of the power cord plug 10.

Further, the outside of the power cords 22 and the data lines 28 is coated with the insulating layer 220 respectively, then an insulating layer 220 coats at the outside of the power cords 22 and the data lines 28, which have been respectively coated with the first insulating layer 222 and the second insulating layer 224, as the power cords 22 and the data lines 28 are deployed in the same cable 20, the circuit layout of the electrical device can be simplified, meanwhile the power cords 22 and the data lines 28 are respectively coated with the insulating layer 220, so there are enough gaps between the data lines 28 and the power cords 22 to separate strong wires from weak wires, the electrical conduction between different circuits can be cut off to guarantee the safety of use, and the interference of the power cords 22 to the data lines 28 can also be avoided. Further, as the communication device 104 is arranged at the outside of the electrical device, the working reliability and stability of the communication device 104 are guaranteed, and the beauty of the overall appearance of the electrical device is guaranteed.

Further, the communication device 104 and/or the single antenna 106 are/is designed on the position of the power cord plug 10, so the problems of shielding, high temperature, interference, beauty and the like of the communication device 104 can be solved. Due to the power cord 22 connector 12, the power cord 22 (including the conducting wire 26) is not fixed to the electrical device, but is connected with the electrical device by adopting a pluggable interface form, the detachable power cord 22 is more convenient for the movement of the electrical device and can also protect the connecting site of the power cord 22 and the electrical device from being damaged in a carrying process, meanwhile, when the power cord 22 is faulty and may not be maintained, only the power cord 22 is replaced, and the electrical device can be used continuously.

In an embodiment of the present disclosure, the electrical device is a household appliance, including: a microwave oven, a microwave oven, an oven and a water heater.

In the embodiment, the power cord plug 10 or the power cord structure 1 is applied to the microwave oven, the oven and the water heater, the user can conveniently and remotely control these household appliances, including, but not limited to, opening and closing the household appliances, setting expected values, adjusting operation modes and the like, and can also transmit menus to the microwave oven, the microwave oven and the oven for automatic cooking. The application range of the present disclosure is not limited to the several manners listed above.

In the present disclosure, the term “plural” means two or more, unless otherwise expressly stated. The terms “mounted”, “connected”, “connection”, “fixed” and the like should be generally understood. For example, the “connection” may be a fixed connection, may also be a detachable connection or an integrated connection; and the “connected” may be directly connected and can also be indirectly connected through an intermediate medium. disclosureln the description of the present specification, the description of the terms “one embodiment”, “some embodiments”, “embodiments” and the like means that the features, structures, materials or features described in combination with the embodiments or examples are included in at least one embodiment or example of the present disclosure. In the present specification, the schematic expression of the above-mentioned terms does not necessarily refer to the same embodiment or example. Moreover, the features, structures, materials or features described may be combined in arbitrary one or more embodiments or examples in any suitable manner.

What is claimed is:

1. A power cord plug for a power cord, comprising:
a shell;
an antenna arranged in the shell; and
a communication device arranged in the shell and connected with the antenna.

2. The power cord plug of claim 1, further comprising:
a conducting wire, wherein one end of the conducting wire is connected with the communication device or the antenna, and the other end of the conducting wire is connected with the electrical device.

3. The power cord plug of claim 2, wherein,
the power cord plug is of an integrated sealed structure.

4. The power cord plug of claim 2, wherein,
the shell is detachably mounted on the power cord plug.

5. The power cord plug of claim 4, further comprising:
a cover body, wherein the cover body is detachably arranged on the shell.

6. The power cord plug of claim 5, further comprising:
a protective sheath sheathed on the communication device or the antenna for protecting the communication device or the antenna.

7. The power cord plug of claim 1, wherein,
the communication device is a wireless communication device.

8. The power cord plug of claim 7, wherein,
the wireless communication device comprises at least one of the following devices: a wifi device, a Bluetooth device and an infrared device.

9. A power cord structure for an electrical device, comprising:
a power cord plug comprising a shell, an antenna arranged in the shell, and a communication device arranged in the shell and connected with the antenna;
a power cord connector; and
a power cord, wherein one end of the power cord is connected with the power cord plug, and the other end of the power cord is connected with the power cord connector.

10. The power cord structure of claim 9, wherein, t
he conducting wire and the power cord are of an integrated structure, and the conducting wire is integrated in the power cord.

11. The power cord structure of claim 10, wherein,
the power cord connector comprises:
a power cord interface connected with the power cord; and
a data line interface connected with the conducting wire.

12. The power cord structure of claim 11, wherein,
the power cord at least comprises a power live wire and a power zero line.

13. A power cord structure for an electrical device, comprising:
a power cord plug; and
a cable component connected with the power cord plug;
wherein the power cord plug comprises:
a shell;
a communication device arranged in the shell; and
a power supply connecting terminal connected with the shell and located below the shell, and the shell and the power supply connecting terminal are formed into a rubber power cord plug by injection molding.

14. The power cord structure of claim 38, wherein the cable component comprises:
a power cord connected with the power supply connecting terminal; and
a signal line connected with the communication device, wherein a metal foil is arranged in the signal line; and
wherein a rubber layer is arranged between the power cord and the signal line for insulating.

15. The power cord structure of claim 14, wherein,
the cable component is of an integrated structure, and rubber coats at the outside of the power cord and the signal line.

16. The power cord structure of claim 13, wherein,
the shell comprises:
a first cover body; and
a second cover body, wherein the second cover body is matched with the first cover body, a hollow cavity is formed after the first cover body and the second cover body are mounted, and the communication device is arranged in the cavity.

17. The power cord structure of claim 16, wherein,
a connection part is arranged on one of one side of the second cover body facing to the power supply connecting terminal and the power supply connecting terminal, a mounting part matched with the connection part is arranged on the other one of one side of the second cover body facing to the power supply connecting terminal and the power supply connecting terminal, and the shell and the power supply connecting terminal are connected by the coordination of the connection part and the mounting part.

18. The power cord structure of claim 17, wherein,
the connection part is a buckle, and the mounting part is a slot.

19. The power cord structure of claim 13, further comprising: a protective sheath sheathed on the communication device for protecting the communication device.

20. The power cord plug of claim 5, wherein,
a buckle is arranged on one of the shell and the cover body, and a slot matched with the buckle is arranged on the other one of the shell and the cover body.
